(19) United States
(12) Patent Application Publication
(10) Pub. No.: US 2006/0242326 A1
(43) Pub. Date: Oct. 26, 2006

(54) System and method for independently enforcing time based policies in a digital device

(76) Inventor: Noam Camiel, Tel-Aviv (IL)

Correspondence Address: NOAM CAMIEL;APT. 4, 47 BILU ST., TEL-AVIV, 64256, IL

(21) Appl. No.: 11/406,321

(22) Filed: Apr. 19, 2006

Related U.S. Application Data
(60) Provisional application No. 60/672,954, filed on Apr. 20, 2005.

(51) Int. Cl. G06F 15/16

(52) U.S. Cl. 709/246

(57) ABSTRACT

A method and system for enforcing time based usage policies for resources within a digital device without requiring a continuous power source and without requiring a connection to a secure server following an initial connection. Several embodiments of time measuring apparatus are presented.

### CROSS-REFERENCE TO RELATED APPLICATIONS

This application claims the benefit of U.S. Provisional Patent Ser. No. 60/672,954, filed Apr. 20, 2005 by the present inventor.

### FIELD OF INVENTION

This invention generally relates to electronic devices that require an independent knowledge of time.

### BACKGROUND OF THE INVENTION

Electronic digital media devices referred herein as media devices are digital devices that include digital media storage. Some examples are mobile phones, multimedia players and flash drives. Some of these digital devices contain software and digital content such as audio files. Some can receive new digital content or software.

In some cases there exists a requirement to protect digital data in various ways such as duplication in the case of copyrighted digital data. In some cases digital data is protected with a policy based on time, such as the ability to use the digital data for a specified amount of time or until a specified time is reached. In these cases the device is required to know the current time or to tell when a specified time has elapsed in order to enforce these time based policies.

Digital devices that make use of protected digital data usually have a means to measure time. The user of the digital device can usually change the device set time. In other cases the user can remove the power source of the device, causing the time measuring module to stop functioning. In such cases, some connection to an external server may be required in order to set the time. However requiring a connection to an external entity such as a secure server or an external appliance is not always possible and is therefore a disadvantage for the user.

In some devices, an internal battery powered clock may be embedded. This however is more costly, and battery may run out at some point.

There is thus a widely recognized need for a digital device to be able to independently enforce data usage policies based on time, and it would be highly advantageous to have such a system devoid of the above limitations.

### SUMMARY OF THE INVENTION

According to one aspect of the present invention there is provided an autonomous digital device comprising:
a physical non-volatile data storage;
an independent time measuring unit for measuring time duration without a continuous supply of power;
an access limiting unit capable of limiting access to at least part of said non-volatile storage;
a connection unit capable of receiving data from an external source;
whereby a time reading is received from an external source through said connection unit and stored in said non-volatile storage, and said independent time measuring unit measures time duration between said received time reading and current time to allow said access limiting unit to enforce time based usage policies without further connection to an external source and without a continuous power source.

According to a second aspect of the present invention there is provided a method of enforcing time dependent usage policies on data resources within a digital device without having a continuous power source, the method comprising:
a. receiving initial time from a source external to said digital device,
b. storing said initial time in non-volatile memory,
c. resetting a time measuring unit capable of operating without a continuous supply of power,
d. adding measurement of said time measuring unit to stored said initial time to get an independent current time measurement,
e. restricting access to data relating to said data resources according to said independent current time measurement and said time dependent usage policies.

According to a third aspect of the present invention there is provided a method of enforcing time dependent usage policies for downloadable content in a digital device without having a continuous power source, the method comprising:
a. downloading content having time dependent usage policies from a server,
b. receiving initial time from said server,
c. storing said initial time in said digital device non-volatile memory,
d. resetting a time measuring unit capable of operating without a continuous supply of power,
e. adding measurement of said time measuring unit to stored said initial time to get an independent current time measurement,
f. restricting access to data relating to said content according to said independent current time measurement and said content time dependent usage policies.

According to a fourth aspect of the present invention there is provided a time measuring apparatus, capable of measuring time duration without continuous supply of power comprising:
a time dependent unit that undergoes physical change with time regardless of the presence of a power source;
a measuring unit capable of measuring said physical change in said time dependent unit;
Whereby said measuring unit measures said time dependent unit in a plurality of instances to determine the time passing between said measurement instances regardless of presence of a power source.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings, in which:

FIG. 1 is a block diagram illustration of a media device with an independent internal time measuring module connected to a digital appliance, in accordance with an embodiment of the present invention;

FIG. 2 is a schematic flowchart for the enforcement of time-based policies within a media device in an independent manner, in accordance with an embodiment of the present invention;

FIG. 3 is a detailed illustration of an embodiment of an exemplary independent time measuring module internal to a media device, in accordance with an embodiment of the present invention;

FIG. 4 is a schematic flowchart for calculating the time duration that a device has been without power supply using an independent time measuring module, in accordance with an embodiment of the present invention;

FIG. 5 is a schematic flowchart for calculating the current time using an independent time measuring module and secure non-volatile memory of media device, in accordance with an embodiment of the present invention;

FIG. 6 is a detailed illustration of an embodiment of a second exemplary independent time measuring module internal to a media device, in accordance with an embodiment of the present invention.

FIG. 7 is a block diagram illustration of a time measuring apparatus capable of measuring time duration without continuous supply of power, in accordance with an embodiment of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, and components have not been described in detail so as not to obscure the present invention.

The present invention includes several embodiments that can be realized using an autonomous digital device described herein. In this disclosure an autonomous digital device is described where the device can independently protect content enclosed within device according to time-based policy rules. Digital device can independently protect content with time-based policy rules without requiring a connection to an external entity and without requiring an continuous internal power source.

In the description herein below, the term “non-volatile storage” refers to storage media that remains unchanged when power is shut off. For example, flash memory and hard-drive magnetic media.

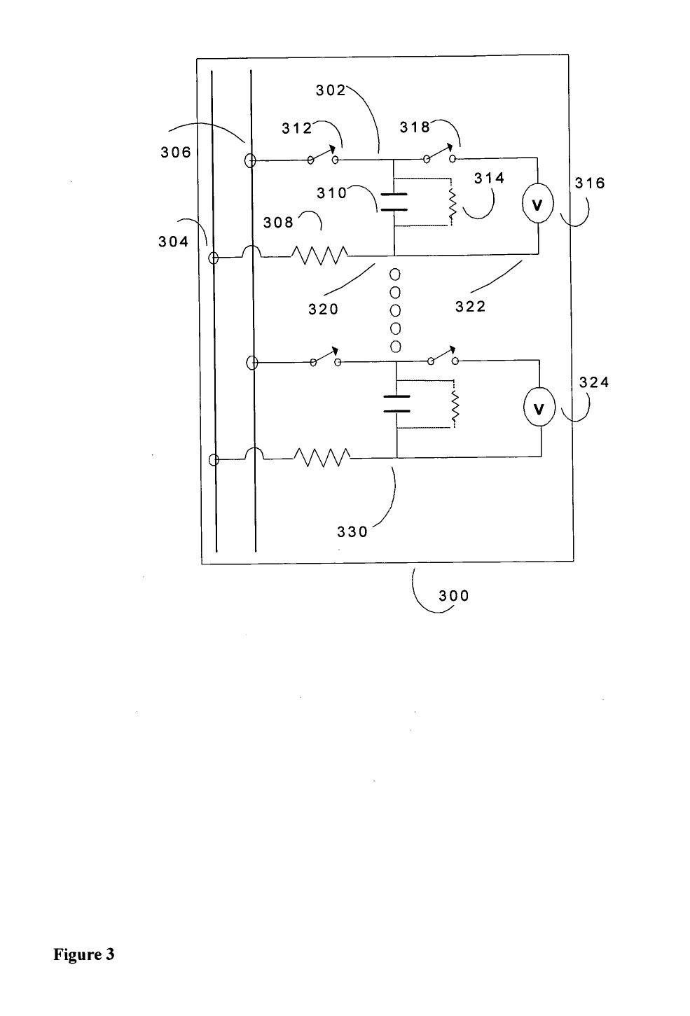

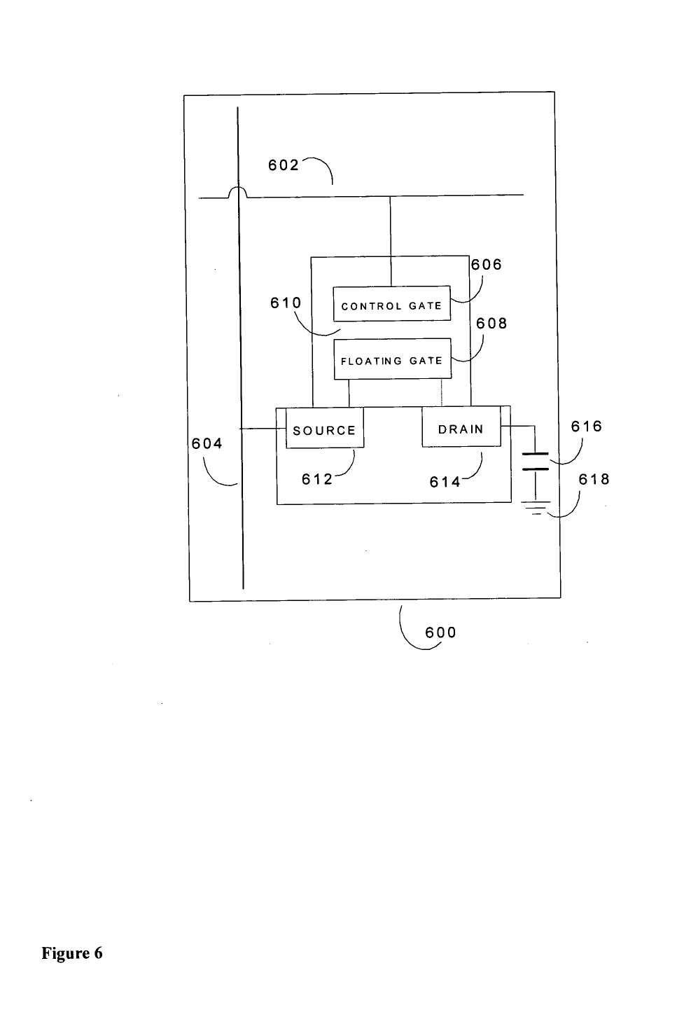

In the description below, the term “independent time estimation unit” refers to a unit able to estimate the duration of a passing period of time within a certain range of accuracy, without a continuous power source. Examples of such a unit is presented in FIG. 3 and FIG. 6.

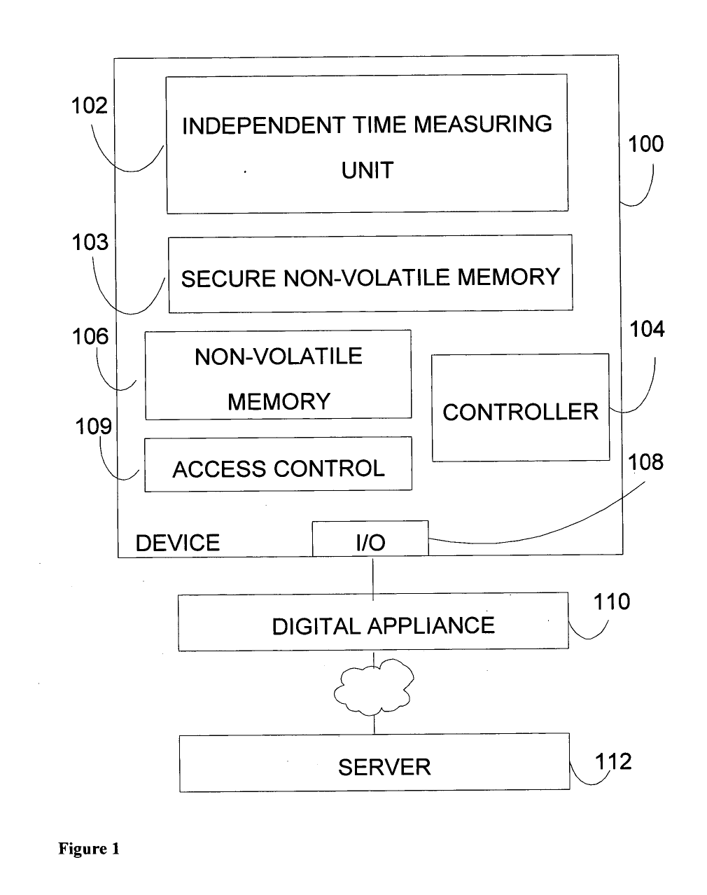

Reference is now made to FIG. 1, which is a block diagram illustration of a media device with an independent internal time measuring module connected to a digital appliance, in accordance with an embodiment of the present invention comprising a media device 100 connected to a digital appliance 110. The media device 100 includes an independent time measuring unit 102, secure non-volatile storage 103, an internal controller 104 non-volatile memory 106, access control unit to non-volatile memory 109 and an 110 module 108. The digital appliance 110 is connected to a server 112 through the network. The secure non-volatile storage 103 may contain data relating to the time when the device was last active such as current time or estimated time range. Initial time may be received through a secure connection of media device 100 to a trusted server 112 through a network connection of digital appliance 110. Content with a time-based policy may be downloaded from the server. Device may have an internal powered clock used when the device is active. This internal powered clock is not shown in the drawing and may assist in determining the current time. Independent time measuring module 102 is capable of measuring a period of time even when the device has no connection to a power source. An example of such a module is presented in FIG. 3. The time measurement result of module 102 may be given within a range of minimum and maximum time. Following device disconnection from its power source, such as by removal from digital appliance 110 or by battery removal, an internal powered clock stops functioning but independent time measuring module 102 does not. When device is powered up again, stored time in secure non-volatile memory 103 along with time measurement of independent time measuring module 102 can indicate the actual current time within a range of accuracy. This time will be referred to as the internal independent determined time. The accuracy of the internal independent determined time depends upon the accuracy of module 102 regarding the time that has passed.

In some embodiments, digital appliance 110 may include a clock and report its current time to the media device 100 through I/O module 108. The time received from digital appliance 110 could be false and is not trusted automatically. The time received from digital appliance 110 is checked to be within the accepted range of internal independent determined time. If the time reading from digital appliance is consistent with internal independent determined time, then time reading may be accepted as the updated current time. Otherwise media device may ignore external reading or limit device protected files, for example until a secure connection to a trusted server is established.

The determined internal current time is stored in secure non-volatile storage 103. Secure non-volatile storage 103 cannot be accessed from digital appliance and is protected from being tampered with. During device operation, independent measuring unit 102 may be reset to prepare for the next device power down, while an internal powered clock (not shown in FIG. 1) keeps track of the time passing while device is on. In some embodiments, once in every certain period when the device is on the current time is stored in secure non-volatile memory 103 and independent time measuring unit is reset.

With independent time measuring unit and secure non-volatile memory, media device may independently calculate the current time or have a knowledge of the minimum time that has passed from a past trusted time measurement. With this knowledge of time, media device may enforce time-based policies for content having time based policies. For example, access control unit 109 may limit data usage within non-volatile memory 106, based on policies stated in secure non-volatile memory 103. The enforcement of the time-dependent policies is made with the prior knowledge of the limitations and approximations of the independent time measuring module 102. Please note that controller 104 may have access to various types of volatile and non-volatile memory such as RAM, ROM, FLASH, EPROM, Magnetic Disk media etc, not included in the drawing for clarity. Please note that other modules may be included in the media device not included in the drawing for clarity.

In some embodiments the media device 100 may not be a separate entity from a digital appliance 110 as illustrated in FIG. 1, but may be a single unit containing non-volatile memory and battery, such as a mobile multimedia player. The separation has been made for clarification and explanation purposes; in some embodiments secure non-volatile memory 103 and non-volatile memory 106 may be combined in a single entity that may allow access protection to certain locations of non-volatile memory.

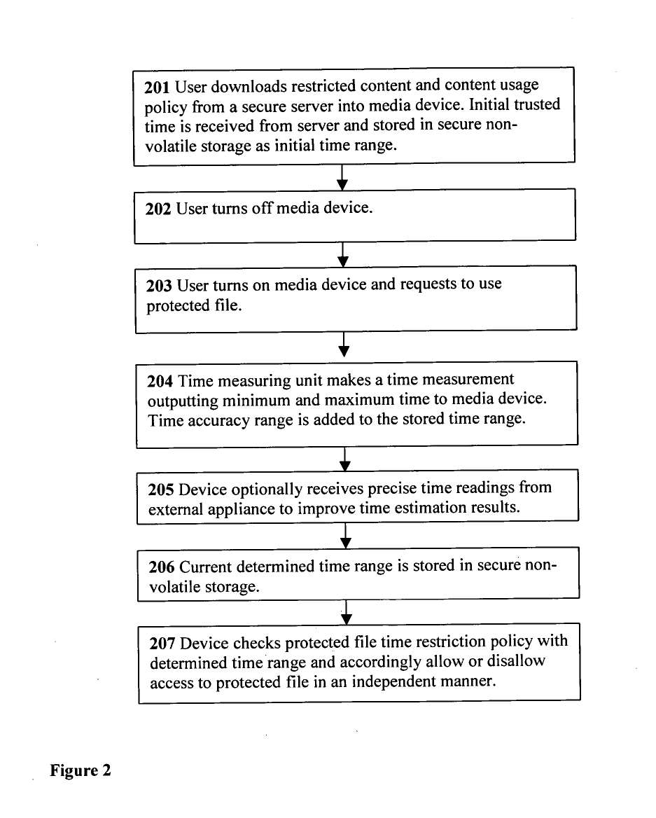

Reference is now made to FIG. 2, which is a schematic flowchart for the enforcement of time-based policies within a media device in an independent manner, in accordance with an embodiment of the present invention.

In step 201 user requests to download content from a secure server into media device. The downloaded content is restricted and can be used according to a downloaded time limiting policy, to be used until a certain time is reached for example. The content restriction is made with the use of access control unit 109. During download process initial trusted time is received from server in a secure communication between media device and server. The secure time is stored in secure non-volatile memory 103 within media device.

In step 202 user turns off the device. Some examples for this may be disconnecting a media device with no independent power source such as a flash drive from a PC, turning off a portable device and removing its batteries etc. This means that any powered clock requiring continuous supply of power cannot be used to determine the current time.

In step 203 user turns on media device. Some examples for this may be connecting a media device with no independent power source to a PC, turning on a portable device etc. The user now requests to use a protected file with a time limiting policy.

In step 204 an independent time measuring unit 102 capable of operating without a continuous power supply within a given accuracy range, makes a time measurement outputting minimum and maximum time to media device. Previous trusted time range is incremented by these values to present current trusted time accuracy range.

In step 205 media device optionally receives a time readings from external digital appliance such as a PC. If the received time falls within current trusted time range calculated by step 204, the external time becomes the current trusted time. Otherwise this time can be ignored or other action may be taken, for example locking protected files until a connection to a trusted server is made and trusted time is once again received.

In step 206 the current determined time range as calculated in steps 204 and 205 is stored in secure non-volatile storage 103. This time measurement will be used as the trusted time of step 204 following the next time device is turned off and on again. At this time independent time measuring unit 103 may be reset to start timing once again.

In step 207 media device checks protected file time restriction policy with independently determined time and can accordingly allow or disallow file usage in an independent manner. The file usage access can be controlled through the access control unit 109.

This series of steps of FIG. 2 displays how the media device with no independent continuous power source can independently enforce time based policies without the need of connecting to the network or even being connected to an external digital appliance following the receiving of content and initial time reading. In this manner the media device with no independent power source, can independency enforce time-dependent policies with no additional connections to any external entity. The manner in which content is downloaded securely from a server and the manner in which time is communicated securely with a server is not explained here. There are numerous manners in which this communication could take place. Secure content download along with a usage policy, can be accomplished in a manner explained in patent 60/658,568 by the present inventor. A secure time can also be communicated within a secure file in this manner. Allowing and limiting content usage is also explained in patent 60/658,568.

Reference is now made to FIG. 3, which is a detailed illustration of an embodiment of an exemplary independent time measuring module internal to a media device, in accordance with an embodiment of the present invention comprising a time measuring module 300 which includes an array of separate modules 302 being the first one and module 330 the last. Each module comprises an independent circuit comprising connectors to power supply 304 and 306 (a DC voltage source), a resistor 308, a capacitor 310, a switch 312 to close a circuit of capacitor 310, resistor 308 and power supply. This circuit will be referred herein as the charging circuit 320. Each module comprises an independent circuit comprising a voltmeter 316, and a switch 318 to close a circuit of capacitor 310, and voltmeter 316. This circuit will be referred herein as the measuring circuit 222. For each capacitor a virtual resistor 314 has been added to the drawing to denote a leakage or Insulating Resistance (IR). This IR resistor 214 is added since capacitors in reality are non-ideal and act as if a resistor 214 exists. Each of the voltmeters in each of module, from voltmeter 316 in the first module 302 to voltmeter 324 in the last module 330, may have a different sensitivity for measuring different ranges of Voltages.

The description herein describes module 302 and applies to all modules 302 to 330. The charging of a capacitor 310 in module 302, is made while the media device is operational and connected to a digital appliance 110 in this example. In this case power supply is available from the digital appliance and Switch 312 closes, in which case capacitor 310 is charged through the resistor 308 by a DC voltage source 304, 306. The capacitor is charged at the rate of V(t)=V0(1−Eˆ−t/RC) referred to herein as Equation 1, where V0 is the DC voltage source 304, 306; t stands for time, R is the resistance of resistor 308, C is the capacitor 210 E is the natural exponential function. We will refer to tau=R*C as the Time Constant. The process of charging the capacitor 310 to five times the Time Constant can be made quickly, depending on values of resistor 308. While power supply no longer exists and/or Switch 312 is switched off, the capacitor 310 discharges through virtual resistor 314 according to equation V(t)=V0*Eˆ−t/RC referred to herein as Equation 2, where V0 is the Initial voltage across the capacitor 310 once power is removed from capacitor 310. (switch 312 is disconnected and/or power is terminated). t stands for time from when capacitor 310 was removed from power source, R is the resistance of virtual resistor 314, C is the capacitor 310 E is the natural exponential function. As power is connected (switch 312 switched off and/or no power is supplied through 304, 306), switch 318 is closed and voltmeter 316 measures the voltage across capacitor 310. According to the voltage reading V(t), V0 calculation, resistance of virtual resistor 314 and capacitor 310, the time duration t that the module 302 has not been connected to a power source, can be measured according to equation 2. The fact that Equation 2 never fully discharges, and the fact that very sensitive voltmeters exist today, along with very efficient capacitors, it is possible to measure time durations which media device was not connected to a power source, up to limitations of voltmeter 316. It is always possible to tell at worst case that media device has been disconnected from a digital appliance 110 for at least a certain period of time, based on the limitation of the measuring voltmeter 316. Suppose measuring voltmeter 316 minimum reading is VL and the reading falls under that limitation. It is possible to state that the capacitor 310 has not been connected to power source for at least t=RC*ln(Vo/VL) where R is the resistance of virtual resistor 314, C is capacitor 310, Vo initial voltage across capacitor.

The voltage across capacitor 310 may vary dramatically between orders of magnitude of the DC power source 304, 306 to very small values with time according to equation 2. For this reason several modules 302 to 330 are presented, each with a voltmeter with a different sensitivity range for measuring different ranges of voltages. An example for applying a measurement is to first attempt to measure voltage across the capacitor 310 with less sensitive voltmeter 316 in circuit 302, until a valid measurement is reached or until the most sensitive voltmeter 324 is reached.

In some embodiments, the capacitors in each circuit may be different.

In some embodiments a Super Capacitor such as of NEC TOKIN corporation (http://www.nec-tokin.com) may be used as the capacitor(s) in FIG. 3. These capacitors have good voltage holding characteristics for long periods of time in the order of magnitude, which can reach weeks (Self discharge characteristics). These can be used for longer periods of time with the usage of very sensitive voltmeters.

In some embodiments a capacitor may be used to power an internal clock. This clock may be used to give a precise time measurements for a certain period of time. In some embodiments this clock powered by a capacitor may be used in conjunction with another capacitor such as in FIG. 3 for time measurements of a longer period of time with less precision. The capacitor of FIG. 3 can be used for example for time durations longer than the powering capacitor can supply the clock.

In some embodiments one or more circuits may be left uncharged in order to check for hardware tampering. More than a single circuit may be left uncharged.

In some embodiments a single circuit may be used with a single voltmeter; In some embodiments a voltmeter with adjustable sensitivity may be used; In some embodiments different types of capacitors, resistors and/or other components may be used.

In some embodiments a different type of time measuring method may be used, electrical, chemical, physical and so forth. This invention relates to a module that does not require an external power supply while time is being measured and that the mechanism is time dependent so that the elapsed time may be calculated. The use of the RC circuit above is just one simple example among other examples that may be utilized for the purpose of telling how much time (or how much minimum time) has elapsed since power has been removed from media device. One such electrical example is related to the manner in which flash memory operates. This example is explained in FIG. 6.

In some embodiments an RC circuit can be used among a series of circuits, which at a certain voltage across the capacitor level triggers a mechanism to start another discharge. This may occur even with another power source or rechargeable source. This invention may be used in addition to other technologies.

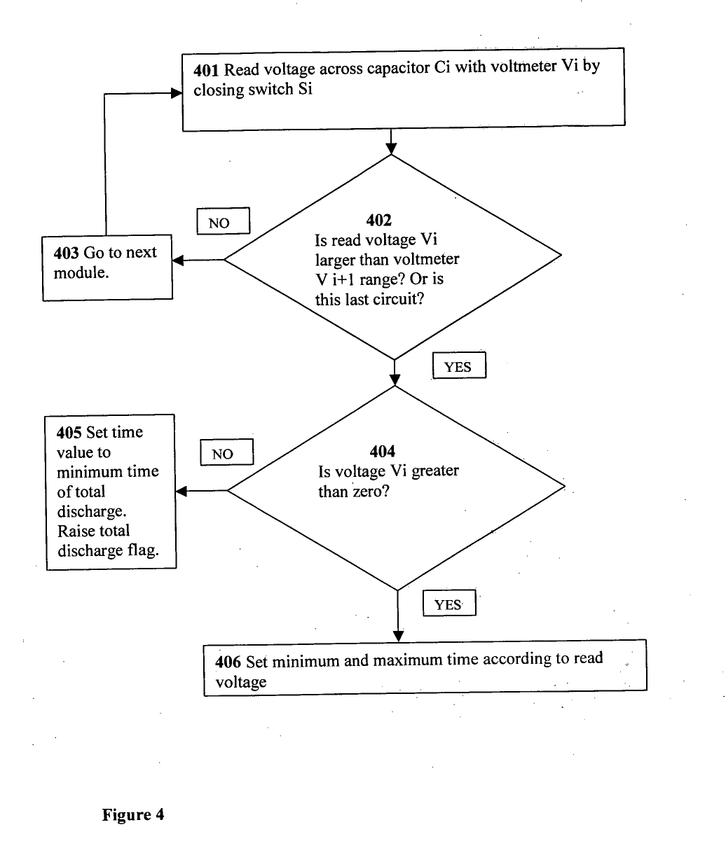

Reference is now made to FIG. 4, which is a schematic flowchart for calculating the time duration that a device has been without power supply using an independent time measuring module, in accordance with an embodiment of the present invention.

In step 401 modules of FIG. 3, 302 to 330 are used. The voltage across the capacitor Ci in module i is read using voltmeter Vi by closing switch Si. Making measurements by the order of module 302 through module 330, an assumption is made that the order of modules 302 to 330 are from greater voltmeter range to a finer voltmeter range in each module.

In step 402 the read voltage in step 401 is checked against the range of the next voltmeter in the next module. If the read voltage is larger than the next voltmeter range in the next module, or if the last module has been reached, step 404 follows. Otherwise, step 403 follows.

In step 403 the next module is chosen and step 401 is repeated for this following module. In this manner finer readings can be made.

In step 404 a check is made whether the final voltmeter reading is greater than zero. If the reading is not greater than zero, this is referred to as reaching the limitation of the voltmeter measurement. If this is reached, step 405 follows. Otherwise, step 406 follows.

In step 405 the voltmeter is not sensitive enough to make a measurement. In this case a minimum time is set to have passed. This minimum time is calculated during device manufacturing and is measured as the minimum time that must have elapsed, in order to discharge the capacitor to this state. Since more time could have actually passed from the minimum time, a flag referred to as Total Discharge Flag is raised, to indicate that significantly more time than estimated may have passed. Accordingly relevant action may follow if required.

In step 406 a minimum and maximum time range is set according to voltmeter reading and factory measurements of the properties of the precision of that reading and accuracy range of the capacitor virtual resistance 314.

This series of steps displays how the time period a media device has not been connected to a power source may be determined or approximated. This period of time may be represented by a time range, or by a minimum elapsed time value.

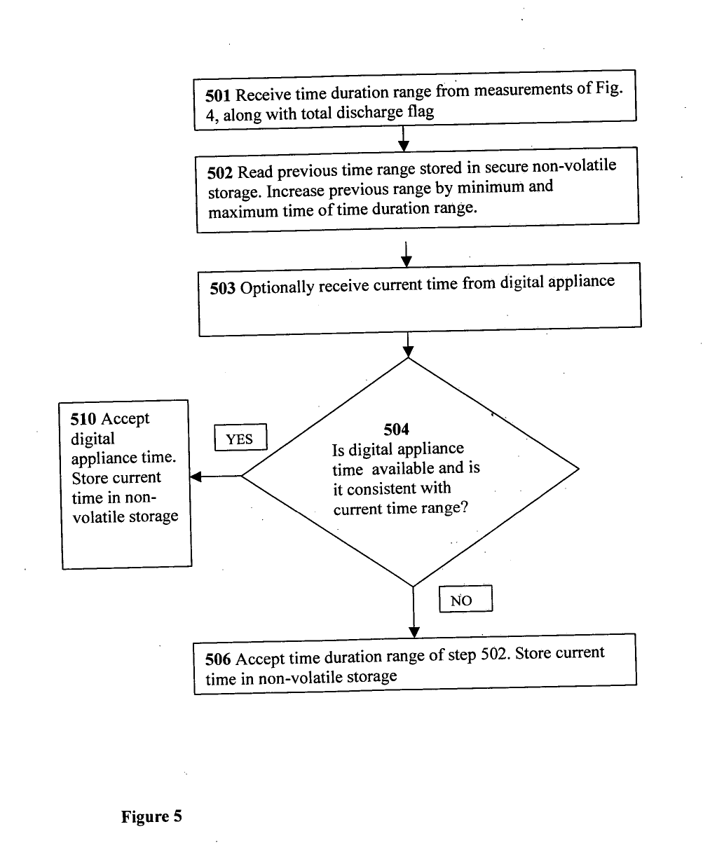

Reference is now made to FIG. 5, which is a schematic flowchart for calculating the current time using an independent time measuring module and secure non-volatile memory of media device, in accordance with an embodiment of the present invention.

In step 501 the time duration that media device has been without a power supply is received. This can be made by method as in FIG. 4 returning a time range with minimum and maximum values. The Total Discharge Flag is also received.

In step 502 the previous recorded time the device was active is retrieved from secure non-volatile storage 103. The minimum and maximum times of the time range of step 501 are added respectively to the previous recorded time to result in the current time range. In case the Total Discharge Flag is set, a minimum current time is determined.

In step 503 the current time is optionally received from digital appliance 110. If no such device exists, step 506 follows.

In step 504 a consistency check is made between the possible current time range from step 502 and the current time reported in step 503. If the result is consistent, step 510 follows. If the result is not consistent, or time from step 503 is not available, step 506 follows.

In step 510 the reported time 503 is accepted as the current time. This time is then updated to secure non-volatile storage 103. In the case where the Total Discharge Flag is set, some of the features of the device may optionally be locked until an authorized trusted server reports the current time in a secure and trusted manner. At this point the independent time measure module 102 may be initialized and prepared for the next power shutdown.

In step 506 the minimum time of step 502 is taken to be the current time. The new current time is updated to secure non-volatile storage 103.

In some embodiments, when current time received from digital appliance 110 is available but does not fall in the expected range of results 502 some limitations may be imposed on the user since this may indicate possible hacking. As an option, some of the features of the device may be locked until a connection to an authorized trusted server is made. Another option is to request the user to enter the current time and/or warn the user. Another alternative is to take no action further than step 506.

This series of steps displays how the current time, may be determined by media device using the time range of FIG. 4 and secure non-volatile storage 103. This series of steps display the possibilities of discovering possible hacking of the device. This series of steps display how the current time may be measured internally, without relying on the time reported by an external source for determining the current time.

Reference is now made to FIG. 6, which is a detailed illustration of an embodiment of a second exemplary independent time measuring module internal to a media device, in accordance with an embodiment of the present invention comprising a cell within a memory chip 600 such that can be found in typical flash memory chips. The cell includes two transistors within a dielectric surrounding material. The two transistors are separated by layer of dielectric oxide 610. One transistor is called the control gate 606 and the other transistor the floating gate 608. The control gate 606 is connected to the wordline 602. The floating is connected to the wordline only through the control gate. An electrical charge comes from the bitline 604, enters the floating gate 608 through the source connection 612 and leaves the floating gate 608 through the drain 614 connected to the capacitor 616 and ground 618. When the media device 100 is connected to a power source, wordline is applied an electric charge. An electrical charge is then applied to the bitline 604, enters the floating gate 608 and drains to the ground 618. This charge causes the floating gate transistor to become an electron gun and through a tunneling effect, referred to as Fowler-Nordheim tunneling, electrons are pushed through and trapped on the other side of dielectric oxide 610, giving it an electric charge. The electrons of the electric charge form a barrier between the control gate 606 and the floating gate 608. The electrons on the surface of control gate 606 are trapped by dielectric oxide layer 610 and cannot leave and later on, media device is removed from power. Although theoretically electrons are not supposed to leave surface of control gate 606 through dielectric oxide layer 610, there are impurities within dielectric oxide layer 610 that cause charge to leak. This leakage is dependent on time and by using a cell with a known leakage factor, or a series of cells with different leakage factors, an approximation of the passed time can be determined as follows. When the device is connected to power, a sensor measures the level of charge passing through the floating gate 608. According to the known leakage factor, an estimation of the passed time is determined, or alternatively, a minimum measure of time is known to have passed.

In some embodiments a series of cells of FIG. 6 using different leakage factors of dielectric oxide layer 610 can be useful to measure the passed time without a power source. This technique of time measurement can be useful to flash memory devices, which already include mechanisms to complete similar tasks.

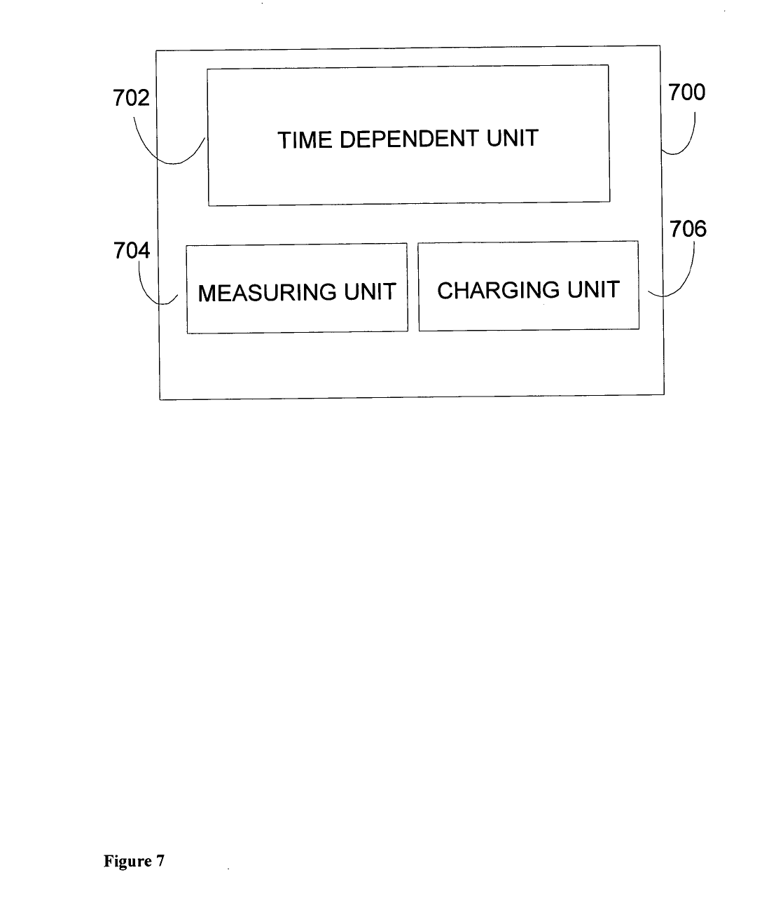

Reference is now made to FIG. 7, which is a block diagram illustration of a time measuring apparatus capable of measuring time duration without continuous supply of power, in accordance with an embodiment of the present invention comprising a time measuring apparatus 700. The time measuring apparatus 700 includes a time dependent unit 702, a measuring unit 704 and a charging unbit 706. Time dependent unit 702 undergoes physical change with time regardless of the presence of a power source. Measuring unit 704 is capable of measuring the physical change in time dependent unit 702. Charging unit 706 is capable of charging time dependent unit 702 when a power source is available. FIG. 3 and FIG. 6 are embodiments of such time measuring apparatus.

It may be appreciated by those skilled in the art of the present invention that the following advantages exist in this invention, over the existing mechanisms:
(a) With the present invention, a media device can independently enforce time-dependent usage policies for content held within device. The media device does not require an internal power source to carry out these usage policy enforcements.
(b) The present invention allows the media device to accept insecure reported time from an external source, such as a digital appliance and be able to accept it or to reject it. In this manner, hacking attempts may be revealed and treated properly. The current time from external source becomes usable and reliable.
(c) The present invention allows a media device to independently enforce a time dependent usage policy without receiving any current time information from an external source such as a digital appliance.
(d) The present invention allows enforcing time dependent usage policies for content within media device without requiring a connection to a secure server over the network to receive an authorized current time. In case of suspected hacking, the device may lock some or all of its internal contents until such a connection over the network is made.

### CONCLUSION, RAMIFICATIONS AND SCOPE

Accordingly, the reader will see that the closure of this invention provides a method for a media device to independently enforce time dependent usage policies even when a device does not include an internal power supply to be used for keeping time while device is off. This means that time-dependent models can be introduced to digital content on devices, which do not include an internal power source with an internal clock. These time-dependent models can be introduced to withstand hackers who may attempt to tamper with the time reported to the device, attempting to bypass time-dependent usage policies of the device-protected content.

Furthermore the media device with independent enforcement of time based policies has additional advantages in that:
(a) The media device can make use of a non-secure time received from a digital appliance. The received time can either become confirmed, and improve internal time measurement precision or can be rejected as a possible hacking attempt, and handled accordingly.
(b) The media device can enforce a time dependent usage policy even without receiving any current time information from a digital appliance.
(c) The media device can enforce time dependent usage policies for content within device independently, without a requiring connection to a secure server over the network in order to receive an authorized current time.
(d) The media device can reveal hacking attempts, allowing the device to lock some or all of its internal contents until a connection to a secure trusted server over the network is made.

Although the description above contains many specifications, these should not be constructed as limiting the scope of the invention but as merely providing illustrations of some exemplary embodiments of this invention.

For example, a different manner of measuring the time that has passed may be used to the RC circuit presented in FIG. 3; a different method may be used, electrical, chemical, physical and so forth, such as presented in FIG. 6. In FIG. 3 a single circuit may be used with a single voltmeter, an adjustable voltmeter, or a series of voltmeters. Several different circuits with different properties may be used in different combinations. The illustration in FIG. 3 is just one possible simple way of implementing the internal time measuring module. The means of FIG. 6 may be used with additional cells of its kind with different characteristics to gain better precision. In addition, the internal time measuring module may be used among a series of other circuits to enhance its capabilities. This may also apply with the use of an additional power source. Additional technologies may also be used along with this invention. Some additional circuits may be added for example to reveal attempted physical tampering. The internal time measuring module may be used in different type of devices, either for media content or for other purposes. Other manners may exists for implementing time measuring than FIG. 4 and FIG. 5 as these are simplified versions correlated to FIG. 3 brought here for simplicity. In some embodiments a capacitor may be used to power an internal clock up to a certain period. This clock may be used to give a precise time measurement. In some embodiments this clock powered by the capacitor may be used in conjunction with a capacitor such as in FIG. 3 for time measurements of a longer period time with less precision. For example for time durations longer than the capacitor can supply the clock. Different approaches may be made when time duration exceeds maximum measurable internal time duration. The device may not be separate from a digital appliance as illustrated in FIG. 1, but may be a single unit containing non-volatile memory and battery, such as mobile music players. The separation has been made for clarification and explanation purposes. This invention may be used for different kind of devices and for purposes including or other than the enforcement of usage policies.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An autonomous digital device comprising:
a physical non-volatile data storage;
an independent time measuring unit for measuring time duration without a continuous supply of power;
an access limiting unit capable of limiting access to at least part of said non-volatile storage;
a connection unit capable of receiving data from an external source;
whereby a time reading is received from an external source through said connection unit and stored in said non-volatile storage, and said independent time measuring unit measures time duration between said received time reading and current time to allow said access limiting unit to enforce time based usage policies without further connection to an external source and without a continuous power source.

2. The autonomous digital device of claim 1, wherein time reading is received through said connection unit from a trusted server in an encrypted form.

3. The autonomous digital device of claim 1, wherein time reading is received through said connection unit to improve internal time accuracy in accordance with internal calculated time.

4. The autonomous digital device of claim 1, further comprising a protected non-volatile storage location for storing received time reading through said connection unit.

5. The autonomous digital device of claim 1, wherein internal calculated time is stored in said non-volatile memory.

6. The autonomous digital device of claim 1, wherein said independent time measuring unit comprises a capacitor and a unit for measuring voltage across said capacitor for calculating time measurement according to said capacitor discharge.

7. The autonomous digital device of claim 1, wherein said independent time measuring unit comprises a surface charged through dielectric material by a Fowler-Nordheim tunneling and a gate separated by said surface through said dielectric material for calculating time measurement according to charge passing through across said gate.

8. The autonomous digital device of claim 1, wherein said independent time measuring unit comprises a capacitor and a powered clock whereby capacitor powers said powered clock.

9. The autonomous digital device of claim 6, further comprising a capacitor and a powered clock whereby capacitor powers said powered clock.

10. A method of enforcing time dependent usage policies on data resources within a digital device without having a continuous power source, the method comprising:
a. receiving initial time from a source external to said digital device,
b. storing said initial time in non-volatile memory,
c. resetting a time measuring unit capable of operating without a continuous supply of power,
d. adding measurement of said time measuring unit to stored said initial time to get an independent current time measurement,
e. restricting access to data relating to said data resources according to said independent current time measurement and said time dependent usage policies.

11. A method according to claim 9 wherein said initial time is received in an encrypted form.

12. A method according to claim 9 wherein said independent current time measurement is stored in said non-volatile memory and said time measuring unit is reset.

13. A method according to claim 9 wherein a received time measurement is compared with said independent current time measurement to improve internal time accuracy.

14. A method of enforcing time dependent usage policies for downloadable content in a digital device without having a continuous power source, the method comprising:
a. downloading content having time dependent usage policies from a server,
b. receiving initial time from said server,
d. storing said initial time in said digital device non-volatile memory,
d. resetting a time measuring unit capable of operating without a continuous supply of power,
e. adding measurement of said time measuring unit to stored said initial time to get an independent current time measurement,
f. restricting access to data relating to said content according to said independent current time measurement and said content time dependent usage policies.

15. A method according to claim 13 wherein said initial time is received in an encrypted form.

16. A method according to claim 13 wherein said independent current time measurement is stored in said non-volatile memory and said time measuring unit is reset.

17. A method according to claim 13 wherein a received time measurement is compared with said independent current time measurement to improve internal time accuracy.

18. A time measuring apparatus, capable of measuring time duration without continuous supply of power comprising:
a time dependent unit that undergoes physical change with time regardless of the presence of a power source;
a measuring unit capable of measuring said physical change in said time dependent unit;
Whereby said measuring unit measures said time dependent unit in a plurality of instances to determine the time passing between said measurement instances regardless of presence of a power source.

19. The time measuring apparatus of claim 18, further comprising a charging unit capable of charging said time dependent unit when a power source is available.

20. The time measuring apparatus of claim 19 wherein said time dependent unit comprises a discharging capacitor, measuring unit comprises a voltmeter for measuring said capacitor voltage and charging unit comprises connection of said capacitor to available power source;

21. The time measuring module of claim 19 wherein said charging unit comprises charging a surface through dielectric material by a Fowler-Nordheim tunneling, said time dependent unit comprises leaking charge of said surface through said dielectric material, and said measuring unit comprises measuring charge passing across a gate separated by said surface through said dielectric material.

22. The time measuring apparatus of claim 19 wherein said charging unit comprises connection of a capacitor to an available power source, said time dependent unit comprises said capacitor powering a clock, and said measuring unit comprises reading time from said clock.

23. The time measuring apparatus of claim 20, further comprising an additional unit for precise measurement comprising a capacitor for powering a clock.
